(19) United States
(12) Patent Application Publication
(10) Pub. No.: US 2005/0187899 A1
(43) Pub. Date: Aug. 25, 2005

(54) Structured document processing method, structured document processing system, and program for same

(75) Inventors: Junichi Odagiri, Kawasaki (JP); Satoshi Nakashima, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/964,736

(22) Filed: Oct. 15, 2004

(30) Foreign Application Priority Data
Feb. 19, 2004 (JP) 2004-42289

(51) Int. Cl. G06F 7/00

(52) U.S. Cl. 707/1

(57) ABSTRACT

The CPU load and amount of memory use are reduced in a structured document processing system that performs extraction, editing, and searching of structured documents. Position information for specific tags which are branches in a structured document is retrieved in advance and held in a position information holding portion, and based on this information, partial documents which are elements, attributes, and element contents are extracted from the structured document. Further, extracted portions can be applied directly to a template for document conversion, to generate other structured documents.

### CROSS-REFERENCE TO RELATED APPLICATIONS

This application is based upon and claims the benefit of priority from the prior Japanese Patent Application No. 2004-042289, filed on Feb. 19, 2004, the entire contents of which are incorporated herein by reference.

### BACKGROUND OF THE INVENTION

1. Field of the Invention

This invention relates to a structured document processing method, structured document processing system, and program for same, to perform processing of structured documents such as SGML (Standard Generalized Markup Language), XML (eXtensible Markup Language), HTML (Hyper Text Markup Language) and other documents, or to convert the original structure thereof.

2. Description of the Related Art

The astonishing spread of the Internet has been accompanied by an increase in the frequency of cases in which data linking a plurality of systems and services via the Internet is written in a structured document. This is because of the need to easily determine and extend the structure of data as data links become more diverse.

Among well-known structured document types are SGML (Standard Generalized Markup Language), XML (eXtensible Markup Language), and HTML (HyperText Markup Language). Such structured documents have, in addition to data, tags which represent the meaning of data.

For example, XML was formally recommended at the W3C (World Wide Web Consortium) in February 1998. In the XML standard, character strings enclosed between the markers “<” and “>” are tags; “<(character string)>” is an opening tag, “</(character string)>” is a closing tag, and the character string enclosed between an opening tag and closing tag is an element. The name of the element appearing within tags is the element name, and information appended to the element is called an attribute.

Each system or service interprets the meaning of data based on such tags to perform processing automatically. Because a structured document is a simple text document, when data is to be appended, the data need merely be inserted, enclosed between the appropriate tags.

By thus adopting a configuration in which tags are embedded in the document to provide a data structure, the data structure is made highly flexible and extensible. And by reading tags and writing tags using meaningful text by humans, the data handled by an independent system can be easily handled by other systems.

For example, processing can be performed to analyze the tags and text in a structured document, with a portion thereof passed to a user application. The user application can perform data processing based on the passed text, and supply the result to various services.

In XML processing, element names, element contents, attributes, text strings, and similar are acquired from the XML document, and are passed to a user application, or contents are modified, appended, or deleted. In such XML processing, a processor is used which conforms to the DOM (Document Object Model), specified and widely used as the XML-standard API (Application Programming Interface) by the W3C.

FIG. 16 and FIG. 17 are explanatory diagrams of the prior art, which explain the above-described DOM processor. Features of a DOM processor include ease of data editing. This is because, as shown in FIG. 16, the DOM processor expands all the data in the XML document 1000 into a tree structure in memory 1100.

As the procedure for searching and editing by a conventional DOM processor, first all the data of the XML document 1000 is expanded into a tree structure in memory 1100, and then the specified data is searched for and edited by tracing the tree structure in memory 1100.

Further, when publishing an XML document on the Web or elsewhere, following data searching and editing by the DOM processor as shown in the above FIG. 16, the document is converted into HTML or PDF on the server side 1200 so that a user can understand the data in the XML document, as shown in FIG. 17. In the past, XSLT (XSL Transformations) specified by the W3C has been used for this conversion. XSLT converts only the necessary tree portions into XML having HTML or another structure, based on the tree structure analyzed by the DOM processor.

The structured document processing by this DOM processor expands all data into a tree structure in memory, and consequently there is a high load on the CPU during expansion in memory; for example, the memory capacity required is four to six times the size of the XML document.

Further, during conversion into HTML the XSLT performs conversion processing while analyzing the tree structure; hence when the tree structure is large, in addition to data processing by the DOM processor, the HTML conversion processing also places a heavy load on the CPU, large quantities of memory are consumed, and time is required to respond to user queries.

In order to resolve such problems with expansion of all data into a tree structure by the DOM processor, methods have been proposed in which the tree structure is divided into partial trees and managed, and the portion of the structured document corresponding to a partial tree being referenced is expanded and converted (see for example Japanese Patent Laid-open No. 2003-178049 and Japanese Patent Laid-open No. 2003-067403).

According to these proposed methods of the prior art, because data is expanded into a partial tree, the CPU load is less than when all data is expanded into a tree structure, and the amount of memory used is reduced; however, because expansion into a tree structure is in any case necessary, there is the problem that the load on the CPU during partial tree expansion is high and the reduction in memory use is insufficient.

Further, processing for conversion into HTML is performed while the XSLT analyzes the tree structure, so that the CPU load is high during HTML conversion processing as well as during DOM data processing, and the amount of memory used is large.

Hence there are the problems that time is required for responses to user queries, and in particular that time is required for search processing of the structured document.

### SUMMARY OF THE INVENTION

Hence an object of this invention is to provide a structured document processing method, structured document processing system, and program for same, for the rapid extraction of required elements from a structured document in response to user queries, to shorten response time.

Another object of this invention is to provide a structured document processing method, structured document processing system, and program for same, for the rapid extraction of required elements from a structured document without expansion into a tree structure, to shorten response time.

Still another object of this invention is to provide a structured document processing method, structured document processing system, and program for same, to lighten the load on the CPU during structured document processing.

In order to attain these objects, a structured document processing method for processing structured documents held in a structured document holding portion has a step of holding in a position information holding portion the position information of a tree in a structured document, and a step of extracting a specified partial document of the above structured document using the above held tree position information.

Further, a structured document processing system of this invention for processing structured documents held in a structured document holding portion has a position information holding portion which holds position information of a tree in a structured document of the above structured document holding portion, and a processing portion to extract a specified partial document of the above structured document using the above held tree position information.

Further, a program of this invention for processing structure documents held in a structured document holding portion causes a computer to execute a step of holding in a position information holding portion the position information of a tree in a structured document and a step of extracting a specified partial document of the above structured document using the above held tree position information.

It is preferable that this invention further has a step of holding the above extracted partial document in a partial document holding portion; a step of deciding whether a partial document for extraction is held in the above partial document holding portion; a step of extracting the above partial document from the above partial document holding portion, when the above partial document for extraction is held in the above partial document holding portion; and a step of extracting the above partial document from the above structured document by using the tree position information, when the above partial document for extraction is not held in the above partial document holding portion.

It is preferable that this invention further has a step of holding, in the above partial document holding portion, an edited partial document in the above structured document.

It is preferable that this invention further has a step of copying unedited portions of the above structured document in the above structured document holding portion, and a step of generating a modified partial document by combining the copied portion with the edited partial document in the above partial document holding portion.

It is preferable that this invention further has a step of extracting internal data of the above partial document from the partial document held in the above partial document holding portion, using the position information in the above position information holding portion.

It is preferable that this invention further has a step of applying the above extracted partial document to a template for structured document conversion, and of performing conversion of the structured document.

It is preferable that in this invention, the above extraction step comprise a step of extracting, as the above partial document, at least one among a region surrounded by specific tags, tag attributes, and a region enclosed between the end of an opening tag and the beginning of a closing tag, according to the position information in the above position information holding portion.

It is preferable that this invention further has a step of storing, in the above structured document holding portion, the above edited partial document and position information held in the above position information holding portion.

In this invention, the position information of specific tags which are branches in a structured document are acquired in advance, and based on these the branches which are elements, attributes, and element contents are extracted from the structured document. Only a portion is extracted from the original structured document, so that compared with conventional methods of acquisition as a tree structure, the load on the CPU can be decreased, and the amount of memory used can also be reduced.

Further, extracted data is applied directly to a document conversion template to generate another structured document. Through this direct application, XSLT conversion becomes unnecessary, and the load on the CPU is further reduced.

### BRIEF DESCRIPTION OF THE DRAWINGS

FIG. 1 shows the overall configuration of a structured document processing system according to an embodiment of the invention;

FIG. 2 explains the structured document of FIG. 1;

FIG. 3 explains the position information of FIG. 1;

FIG. 4 explains extraction operation in the configuration of FIG. 1;

FIG. 5 shows the configuration of a structured document processing system of a first embodiment of the invention;

FIG. 6 explains a first embodiment of the position information of FIG. 5;

FIG. 7 explains a second embodiment of the position information of FIG. 5;

FIG. 8 shows the configuration of the position information holding portion of FIG. 5;

FIG. 9 shows the flow of reference processing in FIG. 5;

FIG. 10 shows the flow of editing processing in FIG. 5;

FIG. 11 shows the configuration of the structured document processing system of the second embodiment of the invention;

FIG. 12 shows the flow of editing processing in FIG. 11;

FIG. 13 shows the flow of storage processing in FIG. 11;

FIG. 14 shows the configuration of the structured document processing system of a third embodiment of the invention;

FIG. 15 shows the flow of search processing in FIG. 14;

FIG. 16 explains the DOM of conventional structured document processing; and,

FIG. 17 explains conventional structured document processing.

### DESCRIPTION OF THE PREFERRED EMBODIMENTS

Below, embodiments of the invention are explained in the order of a structured document processing system, a first embodiment, a second embodiment, a third embodiment, and other embodiments; however, this invention is not limited to these embodiments.

Structured Document Processing System

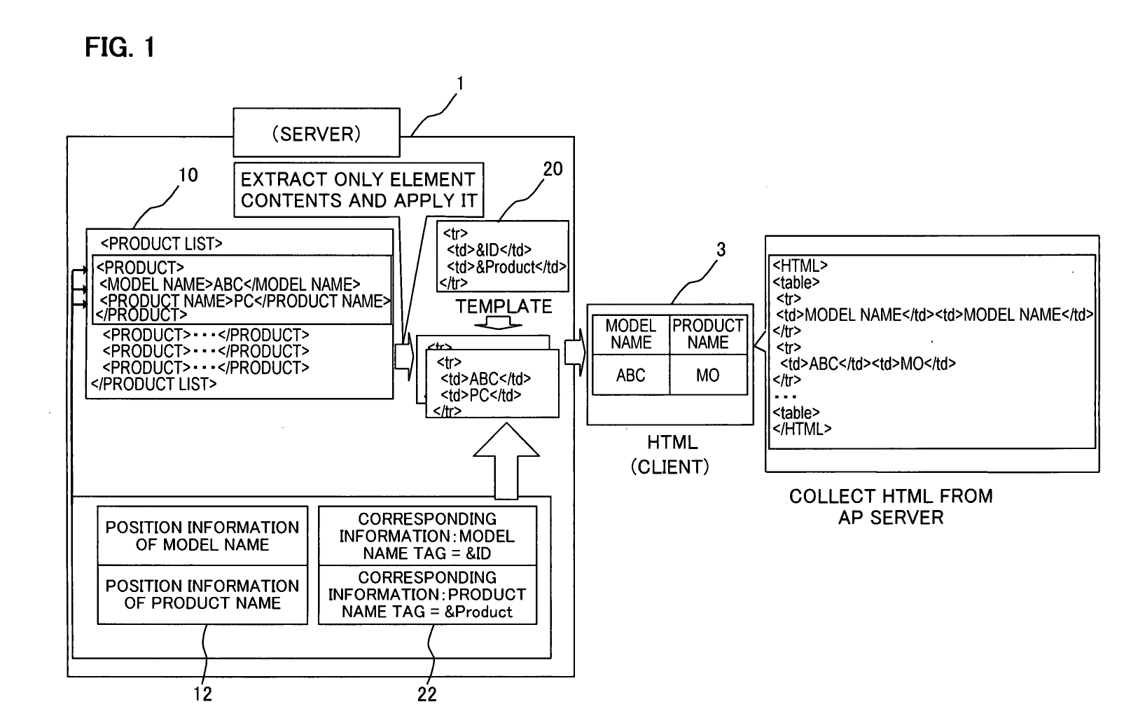

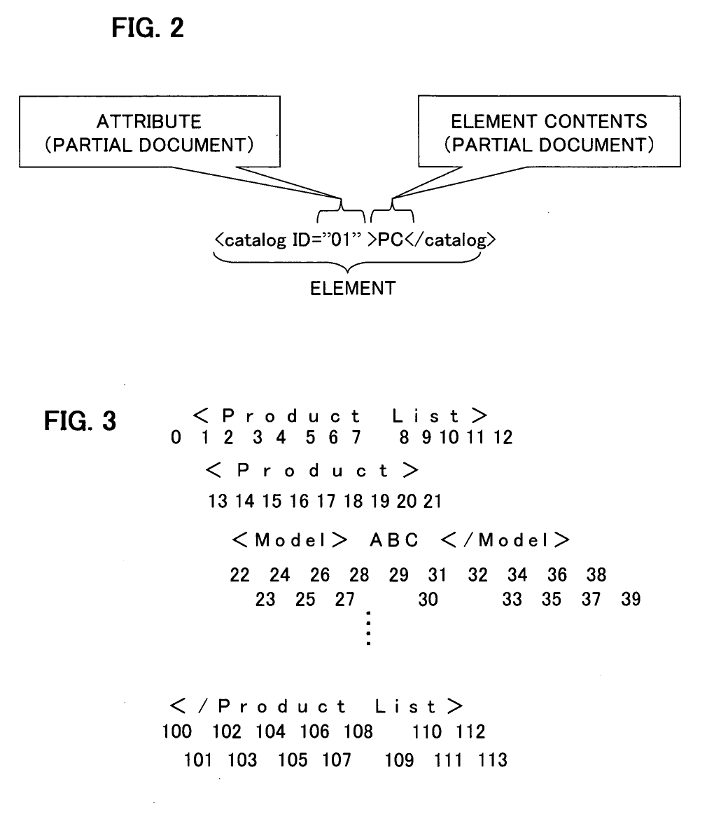

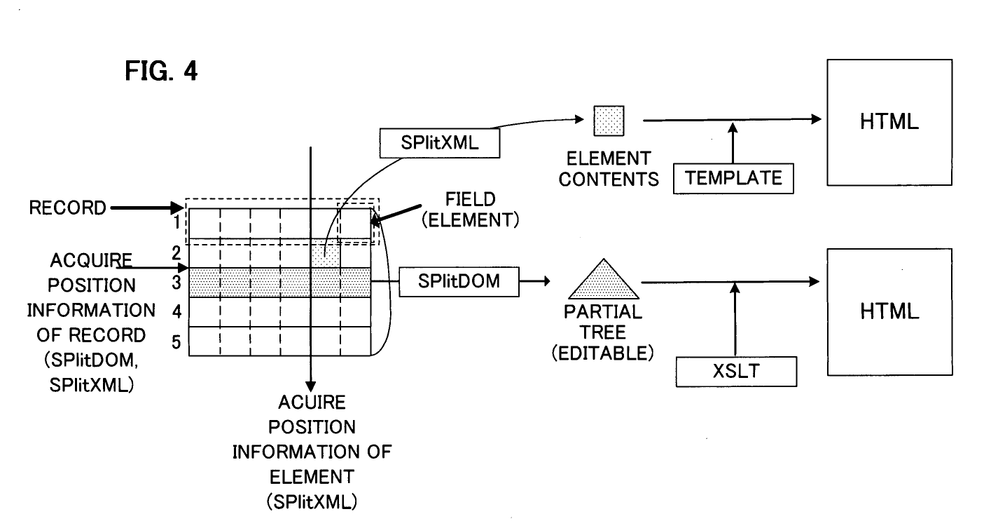

FIG. 1 shows one embodiment of the configuration of a structured document processing system of the invention, FIG. 2 explains the structured document of FIG. 1, FIG. 3 explains the position information of FIG. 1, and FIG. 4 explains the operation of the system of FIG. 1.

As shown in FIG. 1, in a structured document processing system, a client 3 issues a request for referencing, searching, and editing of a structured document to a server 1 having a structured document file (here, an XML document file) 10.

The server 1 acquires in advance position information for specific tags in the structured document 10, and holds this information in a position information holding portion (memory) 12. The server 1 extracts elements, attributes, and element contents from the XML document 10 based on this position information.

In this way, only a portion is extracted from the original XML document 10, so that compared with the conventional method of acquisition as a tree structure, the load on the CPU of the server 1 is reduced.

In order to transmit data to the client 3, an HTML conversion template 20 and template definition 22 are provided at the server 1, and the extracted element contents are directly applied to the HTML conversion template 20 to generate HTML. By means of this direct application, conventional XSLT conversion becomes unnecessary, and the CPU load at the server 1 is reduced.

Specifically, when the structured document 10 of FIG. 1 is represented as a tree structure, the portion from the opening tag <Product List> to the closing tag </Product List> is a tree (parent), and portions from an opening tag <Product> to a closing tag </Product> are partial trees (children); further, portions from an opening tag <Model> to a closing tag </Model> are branches (grandchildren).

Such a branch is called an element, as shown in FIG. 2; within the element appear attributes and the element contents (here, PCs). That is, the actual text string data is attributed and element contents, and these text strings are defined by tags. In the example of the structured document 10 of FIG. 1, as indicated by the numerals in FIG. 3, position information (positions of text strings, or storage positions of text strings of the structured document) are provided.

Position information (in FIG. 1, the “Model” tags, which are branches) defined in this way is acquired in advance from the structured document 10, held in the position information holding portion 12, and is converted in the next procedure.

(1) The position information of a specific tag specified by a user is retrieved from the position information holding portion 12.

(2) Based on the position information, an element, attributes, or element contents, which are branches, are extracted from the original XML document 10.

(3) The extracted element, attributes, or element contents are applied to the HTML template 20.

(4) The HTML created by this application is returned to the user (client).

In this way, only the required element, attributes, or element contents are extracted from within the structured document 10 and managed. Further, by retrieving position information, in the second and subsequent instances of extraction the partial document (element or similar) can be rapidly extracted based on this position information.

In an ordinary DOM or similar, elements, attributes, and element contents are analyzed and held internally for use in expansion into a tree structure. Hence in order to return the data into the original XML document, processing must be performed to merge the analyzed portions. However, when in this invention a partial document is to be output, a portion of the original structured document is simply extracted, so that there is no merge processing. Consequently high-speed extraction becomes possible.

Further, position information is simple numerical data, so that the amount of memory used is smaller than for a tree structure. And, the CPU load on the user application side can be reduced. That is, in a user application there are cases in which only a partial document (element contents which are contained within elements, and element attributes) is required, and not a structured document (element) which is a portion of a structured document.

For example, when a user application performs a search based on element contents, the included tags, rather than being helpful, are unnecessary, and so it is preferable to extract only the element contents from elements. In order to achieve this, the position information for the beginning and end of the opening tags and the beginning and end of closing tags of specific tag types, and of specific tag attributes, are acquired, to extract the element contents and element attributes as partial documents.

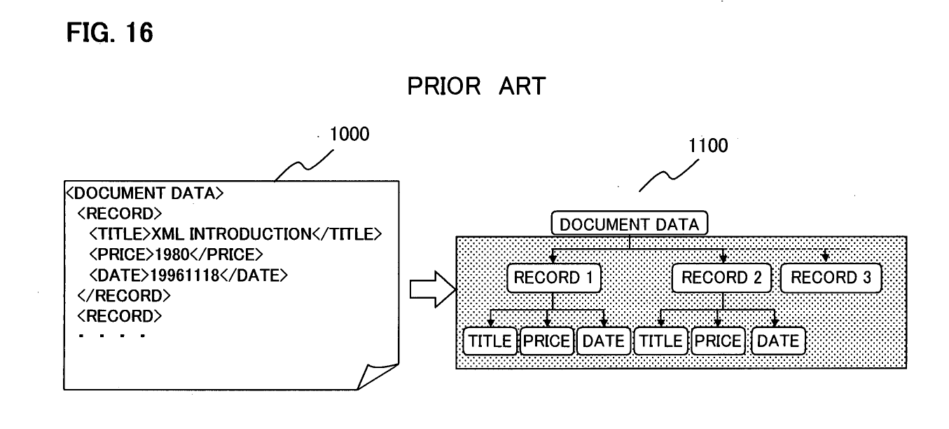

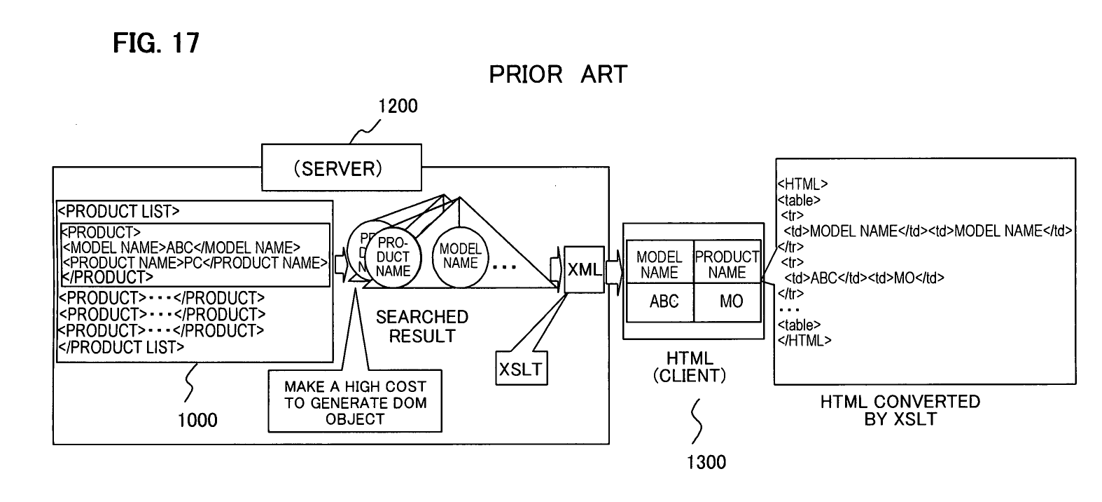

An explanation in terms of file space is given using FIG. 4. As explained in FIG. 16 also, in many cases data is collected to form one record (partial tree), and a plurality of such records exist in one document. In such cases, each record is treated as a partial document and position information for the record is acquired in advance; when there is a need to view internal data (element contents, attributes) in more detail, the position information for specific tags (elements) within records (partial documents) is acquired, and data (element contents) is extracted.

In FIG. 4, this invention is called SPlitXML, and conventional processing using partial trees is called SPlitDOM. In SPlitDOM, position information for records (partial trees) is acquired; but in the SPlitXML of this invention, position information for records (partial trees), and position information for elements (branches) within records, are acquired.

Consequently element contents can be accessed directly, so that the CPU load involved in conversion into another structured document (for example, HTML) can be reduced. As stated above, in SPlitDOM a tree structure is converted, whereas in XSLT the necessary element contents are retrieved while analyzing and interpreting a given tree structure.

As a result, portions of a tree structure can be specified flexibly, but the CPU load is increased correspondingly, and in mobile equipment (mobile PCs, PDAs, portable telephones or similar) with slow CPU calculation speeds, HTML conversion is not practical.

Hence by extracting element contents in an extraction portion and applying these portions prepared in advance to an HTML conversion template 20, it is possible to perform HTML conversion without using XSLT, so that the CPU load is reduced.

First Embodiment

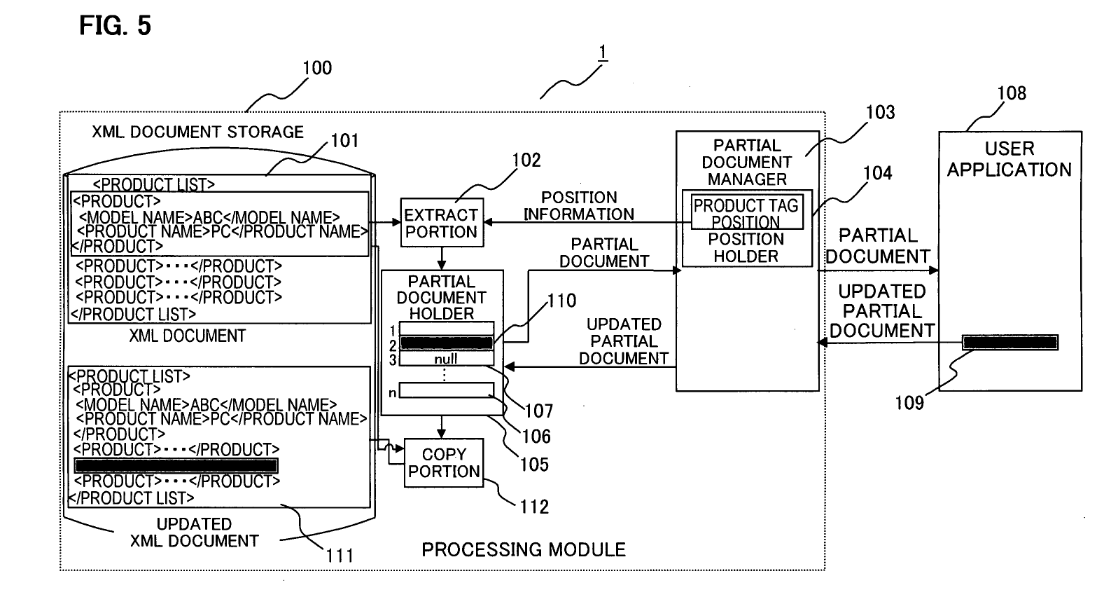

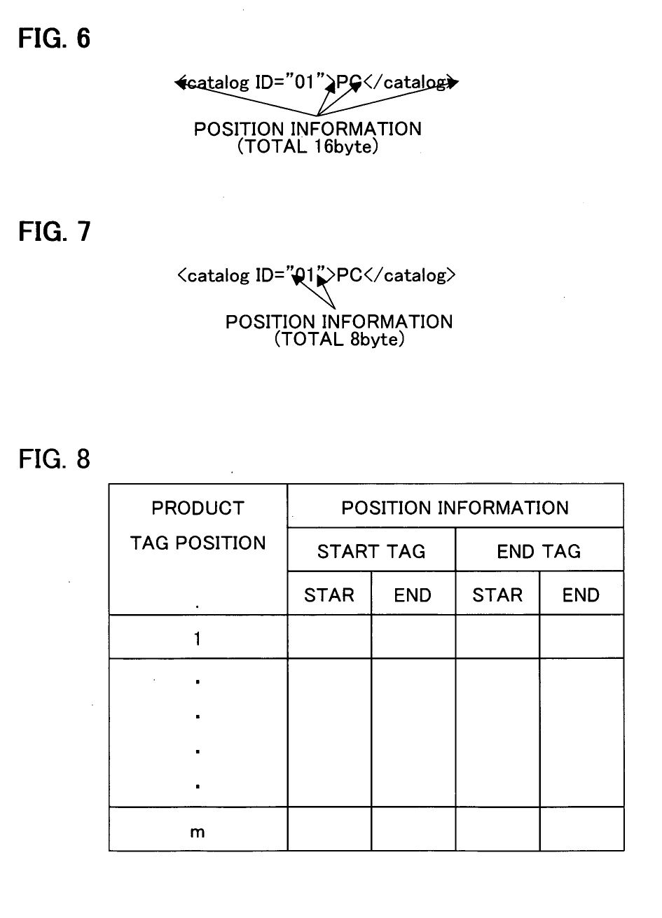

FIG. 5 shows the configuration of a system of a first embodiment of the invention, FIG. 6 explains a first embodiment of the position information of FIG. 5, FIG. 7 explains a second embodiment of the position information of FIG. 5, and FIG. 8 explains the position information holding portion of FIG. 5.

The system of FIG. 5 shows an example in which a portion of an XML document describing product information is referenced and edited by a user application (a client 3). The processing module 1 comprises for example the above-described server, and data for numerous products (product tags) exist in the XML document 101; a portion of the product tags is extracted from the XML document 101 as a partial document and referenced.

The processing module 1 has a file device comprising a structured document holding portion 101, a CPU, memory, and similar. A partial document holding portion 105 and position information holding portion 104 are provided in the memory. The CPU has as functional modules an extraction portion 102, partial document management portion 103, and copy portion 112.

The partial document management portion 103 first retrieves position information from the structured document holding portion 101, and stores the information in the position information holding portion 104. Thereafter, the extraction portion 102 retrieves partial documents from the structured document holding portion 101 based on this position information. The position information holding portion 104 holds position information.

This position information and the position information holding portion are explained in FIG. 6 through FIG. 8. FIG. 6 shows position information for a case in which one element (branch) or the contents of one element are extracted. As shown in FIG. 6, when extracting one element (branch) or the contents of one element, a total of four positions, which are the beginning and end of the opening tag and the beginning and end of the closing tag, are held as position information.

Because each position is expressed using four bytes, there are at most 16 bytes per element. In FIG. 6, a product name element of FIG. 5 is shown. As shown in FIG. 8, the position information holding portion 104 holds a total of four positions, which are the beginning and end of the opening tag and the beginning and end of the closing tag for the element (here, a model name element or product name element) for each product tag i.

In the embodiment of FIG. 6, an element is extracted as a partial document, but when attributes are to be held, the beginning and ending positions of the attribute value (here, 01), a total of 8 bytes, are held, as shown in FIG. 7.

Returning to FIG. 5, the partial document holding portion 105 is a type of cache memory, and as explained below, temporarily holds an extracted or updated partial document. The copy portion 112 creates an updated structured document 111 from the original structured document 101 and the updated partial document.

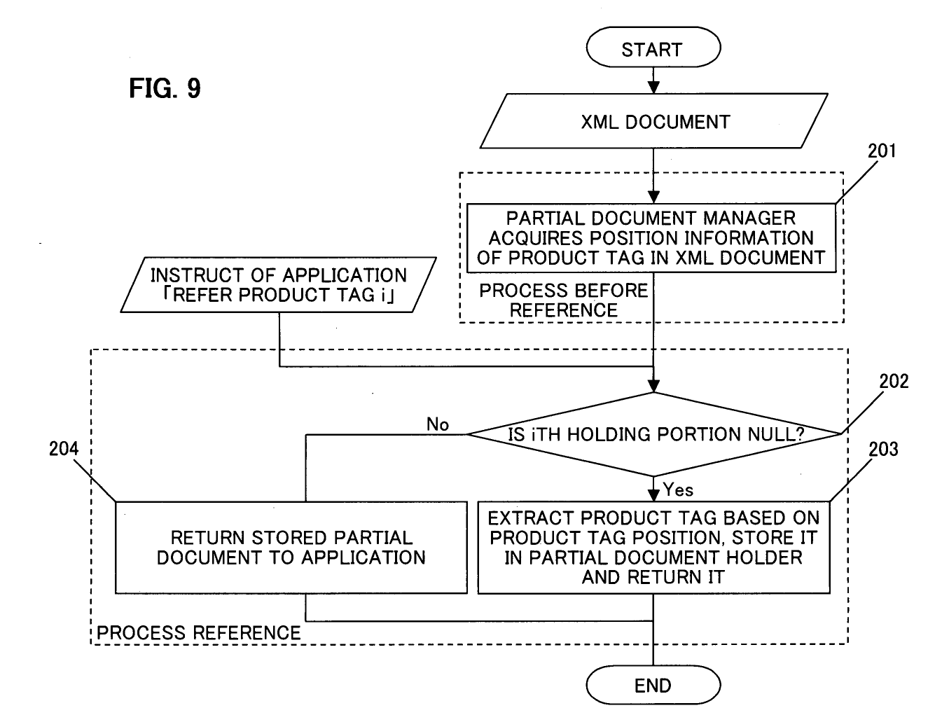

Next, XML document reference processing in the system of FIG. 5 is explained, using the reference processing flow diagram of FIG. 9.

S201: As processing prior to referencing, the partial document management portion 103 retrieves the position information of product tags in the structured document 101 from the structured document holding portion 100, and stores the position information in the position information holding portion 104. That is, as explained in FIG. 6 through FIG. 8, the positions of the opening and closing tags of the element are retrieved as position information for a product tag, and are stored in a table in the position information holding portion 104, as shown in FIG. 8.

In addition to thus retrieving and holding position information for the product tags in the entire XML document 101, one or two among the model name elements, product name elements, and attribute values can be similarly processed, according to instructions by the user.

S202: An instruction to reference the ith product tag is received from the user application 108, and the partial document holding portion 105 judges, via the partial document management portion 103, whether an extracted partial document (document from the beginning to the end of the product tag) is already been stored in the ith record, or whether a partial document has not been stored and “null” is present instead.

S203: If “null” is present, in response to the reply from the partial document holding portion 105 the partial document management portion 103 retrieves the position information of the ith product tag from the position information holding portion 104 and sends this information to the extraction portion 102; the extraction portion 102 extracts the partial document at the specified position information from the structured document holding portion 101, and returns the partial document to the user application 108 via the partial document management portion 103. At this time, the extraction portion 102 stores the extracted partial document in the specified position of the partial document holding portion 105.

S204: When the value is not “null”, the partial document holding portion 105 returns the partial document stored in the specified record to the user application via the partial document management portion 103.

In this way, only the required element, attributes, or element contents (branch) are extracted from the structured document and managed, so that the CPU load and amount of memory use during structured document processing can be reduced. When for example a large amount of data exists, initial search processing is performed to narrow down the results; but the narrowing-down result is a portion of the entire document, so that there is no need to generate a tree structure for all the data. Thus the CPU load can be reduced.

By retrieving position information, the CPU load and memory usage necessary for partial document extraction can be reduced. That is, if position information is retrieved in advance, in the second and subsequent instances of extraction the partial document can be extracted rapidly based on this position information. Further, in an ordinary DOM or similar, elements, attributes, and element contents are analyzed and held internally for use in expansion into a tree structure, so that processing is necessary to merge the analyzed portions when returning the data to the form of an XML document. However, in this invention only a portion of the original structured document is extracted when the partial document is output, so that no merge processing is performed and high-speed extraction becomes possible. Further, position information is mere numerical data, so that less memory is required than for a tree structure.

Also, a partial document holding portion 105 is provided, so that the CPU load for extraction and editing of a partial document can be reduced. Upon each request for extraction or editing from a user application, the CPU load is high when referencing a structured document held in the structured document holding portion 101 and performing extraction or editing.

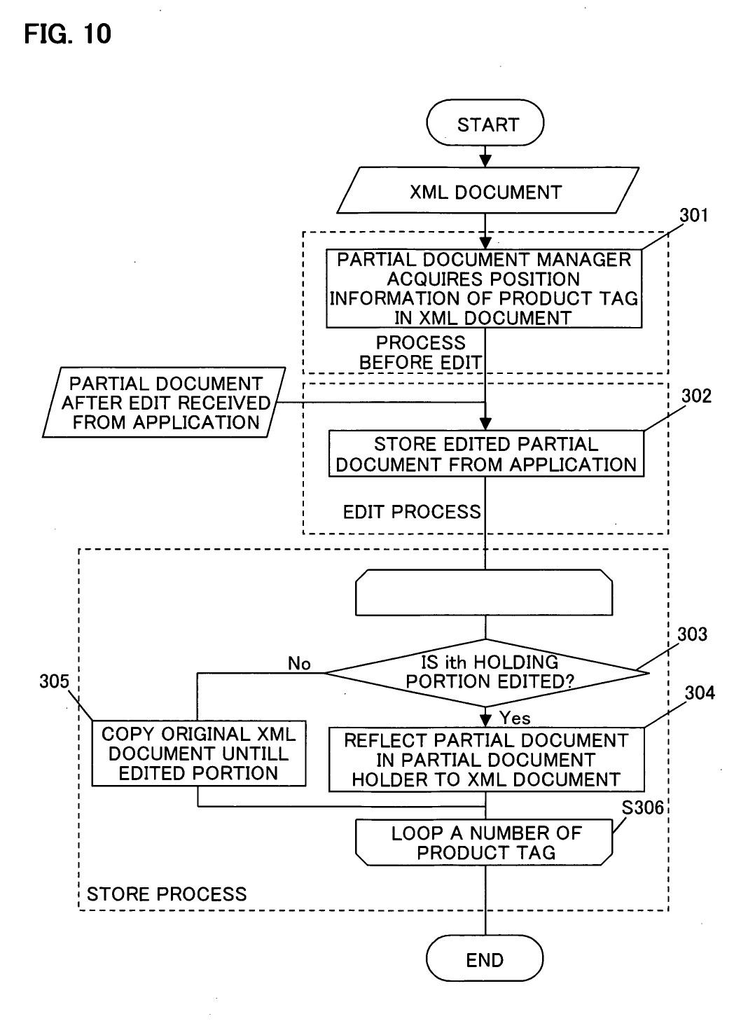

Hence a partial document which has once been extracted is held in the partial document holding portion 105. And as explained below using FIG. 10, when there is an editing request from a user application, the partial document held in this partial document holding portion 105 is replaced with an edited partial document passed from the user application. When the edited result is to be reflected in the original structured document, the partial document is applied to the structured document.

There are cases in which a user application requires only a partial document (element contents which are contained in an element, and element attributes) rather than a partial structured document (elements) of the structured document. For example, when a user application performs a search based on element contents, the included tags, rather than being helpful, are unnecessary, and so it is preferable to extract only the element contents from elements.

In order to achieve this, the position information for the beginning and end of the opening tags and the beginning and end of closing tags of specific tag types, and of specific tag attributes, are acquired in advance, to extract the element contents and element attributes as partial documents. By this means, the CPU load imposed by the user application can be reduced.

Next, editing processing in the system of FIG. 5 is explained, referring to the editing processing flow diagram of FIG. 10.

S301: As editing preprocessing, similarly to step S201, the partial document management portion 103 retrieves position information for a product tag in the structured document 101 from the structured document holding portion 100, and stores the position information in the position information holding portion 104.

S302: The partial document management portion 103 stores an edited partial document 109 (see FIG. 5), passed from the user application 108, in the partial document holding portion 105. By this means, editing processing is completed, and execution proceeds to subsequent storage processing.

S303: The partial document holding portion 105 judges whether the ith partial document has been edited.

S304: If it is judged that the ith partial document has been edited, the partial document holding portion 105 reflects the edited partial document, held in the partial document holding portion 105, in a structured document 111 created in the structured document holding portion 100. That is, the edited partial document overwrites the places for updating in the structured document 111.

S305: If the partial document holding portion 105 judges that editing has not been performed, the copy portion 112 copies the original structured document 101 in the structured document holding portion 100 without modification up to an edited portion, and reflects (copies) this in the updated structured document 111.

S306: S303 and subsequent steps are repeated a number of times equal to the number of partial documents (product tags), and processing ends.

In this way, the CPU load can be reduced when reflecting the editing results of partial documents (product tags) in the original structured document. That is, among partial documents there also exist those which have only been extracted but not edited. In such cases, automatically reflecting unedited partial documents as well in the original structured document results in an increased CPU load. Hence by applying only unedited partial documents to the original structured document, the load on the CPU is reduced.

Second Embodiment

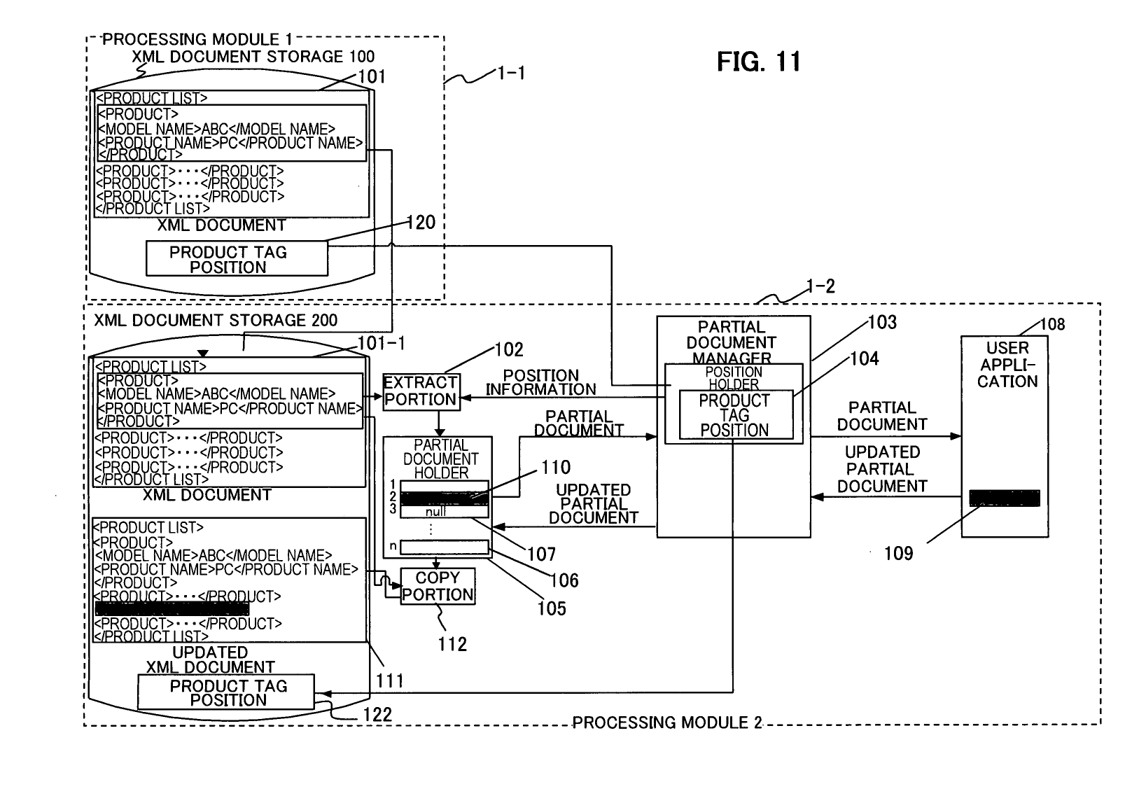

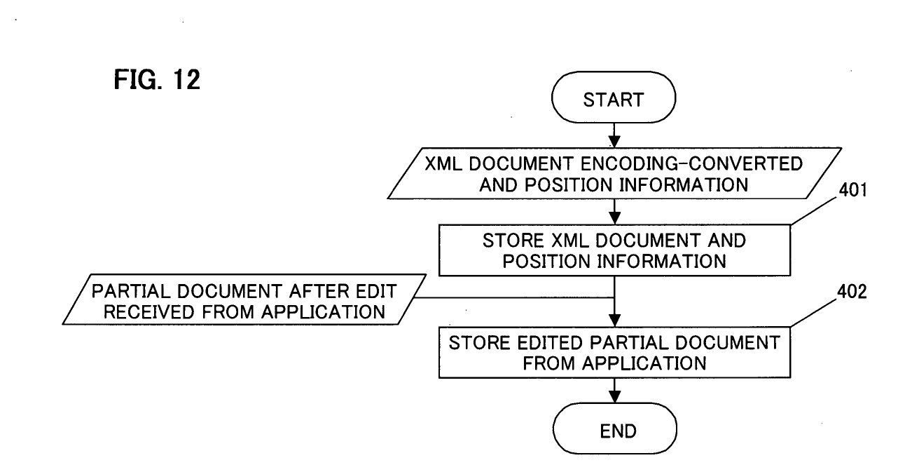

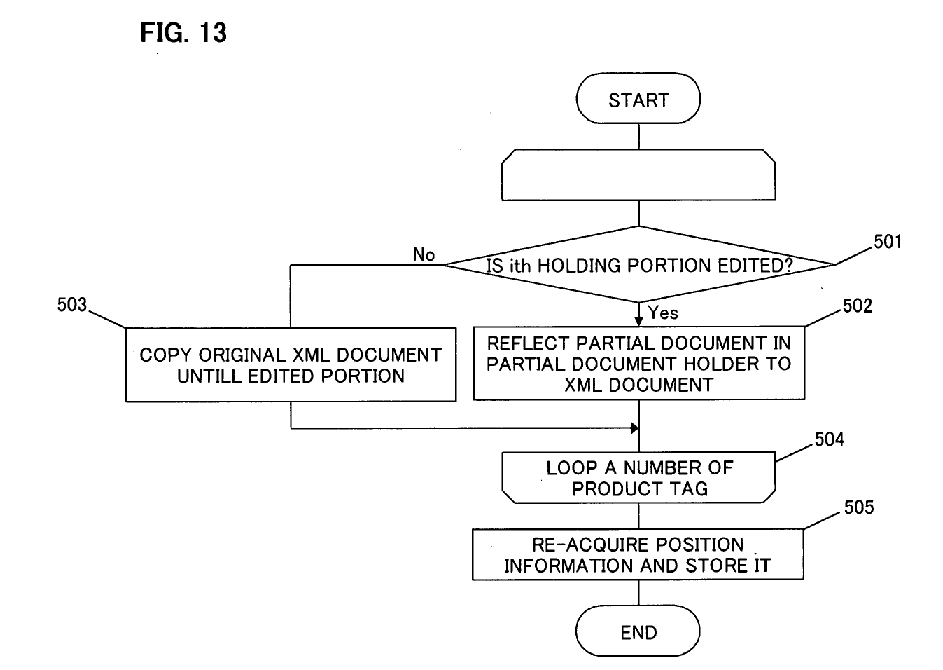

Next, a second embodiment of the invention is explained. FIG. 11 shows the configuration of the system of the second embodiment of the invention, FIG. 12 shows the flow of editing processing, and FIG. 13 shows the flow of storage processing after the editing of FIG. 12.

The system of FIG. 11 is an example in which a structured document holding portion 100 existing in a processing module 1 (1-1) transmits an XML document 101 describing product information to a structured document holding portion 200, and at a processing module 2 (1-2), a user application 108 references and edits a portion of the XML document.

As shown in FIG. 11, data for numerous products (product tags) exist in the XML document 101, and a portion of the product tags are extracted from the XML document and referenced as partial documents. The processing module 1-1 holds the structured document 101 and product tag information in the structured document holding portion 101.

The structured document holding portion 200, extraction portion 102, partial document management portion 103, partial document holding portion 105, and copy portion 112 of the processing module 1-2 are the same as in the embodiment of FIG. 5.

The partial document management portion 105 receives product tag positions from the processing module 1-1, and holds these in the position information holding portion 104. The structured document holding portion 100 of the processing module 1-1 converts the structured document 101 into a character encoding used throughout the processing module 1-1, and then passes the result to the structured document holding portion 200 of the processing module 1-2.

The position information holding portion 104 holds position information; this position information gives positions as the number of characters from the beginning (see FIG. 3). Similarly to FIG. 6, when extracting one element or the contents of one element, the position information is a total of four positions, which are the beginning and end of the opening tag and the beginning and end of the closing tag. As the number of bytes necessary to represent such a position, four bytes are sufficient, as in the first embodiment.

Next, editing processing in the system of FIG. 11 is explained, using the editing processing flow diagram of FIG. 12.

S401: The processing module 1-2 stores, in the structured document holding portion 200 and partial document management portion 103, the structured document 101 and product tag information 120 converted into the encoding used in the processing module 1-2, and sent from the processing module 1-1. In the next and subsequent instances, this may be used as position information, so that the retrieval processing of S301 in FIG. 9 in the first embodiment becomes unnecessary.

S402: The edited partial document 109 passed from the user application 108 is stored in the partial document holding portion 105.

Next, storage processing in the system of FIG. 11 is explained, using the storage processing flow diagram of FIG. 13.

S501: The partial document holding portion 105 judges whether the ith partial document has been edited.

S502: If the partial document is judged to have been edited, the partial document holding portion 105 reflects the edited partial document, in the partial document holding portion 105, in the structured document 111 which has been created in the structured document holding portion 200. That is, the edited partial document overwrites the places for updating in the structured document 111.

S503: If the partial document is judged not to have been edited by the partial document holding portion 105, the copy portion 112 copies the original structured document 101-1 in the structured document holding portion 200 without modification up to an edited portion, and reflects (copies) this in the updated structured document 111.

S504: S501 and subsequent steps are repeated a number of times equal to the number of partial documents (product tags).

S505: The product tag position information in the position information holding portion 104 is saved in the structured document holding portion 200 as the data 122. Hence if in the next and subsequent instances this is used as position information, retrieval processing becomes unnecessary.

In this embodiment, when an edited partial document is stored in the structured document holding portion 200, position information for specific tags or attributes held in the position information holding portion 104 is also stored in the structured document holding portion 200. And when again processing and converting the stored structured documents 101-1 and 111, by using this position information 122, there is no need to perform processing to acquire position information.

Further, a character string search is necessary in order to acquire position information for specific tags or attributes, and the resulting CPU load is high; hence if position information is acquired and held for the second and subsequent instances, or is acquired and held in advance, then the CPU load can be eliminated when actual processing and conversion into a structured document is necessary.

Further, in this embodiment position information is used for addresses in the structured document holding portion 100 indicating the ordinal address counting from the beginning of the structured document as the origin. For example, position information indicating the number of bytes from the beginning is used.

Similarly, position information indicating the number of characters counting from the beginning of the structured document as the origin may be used. When the structured document is in Japanese, depending on the character encoding of the structured document, a single Japanese character may be represented by two bytes. Because different character encoding may be used by different systems, when structured documents and position information are to be exchanged among systems, it is effective to specify the positions of specific tags or attributes as a number of characters from the beginning in such systems.

Third Embodiment

Next, as a third embodiment of the invention, a user application is described which performs searches of model names in an XML document with product information, and displays product information as search results on a Web browser.

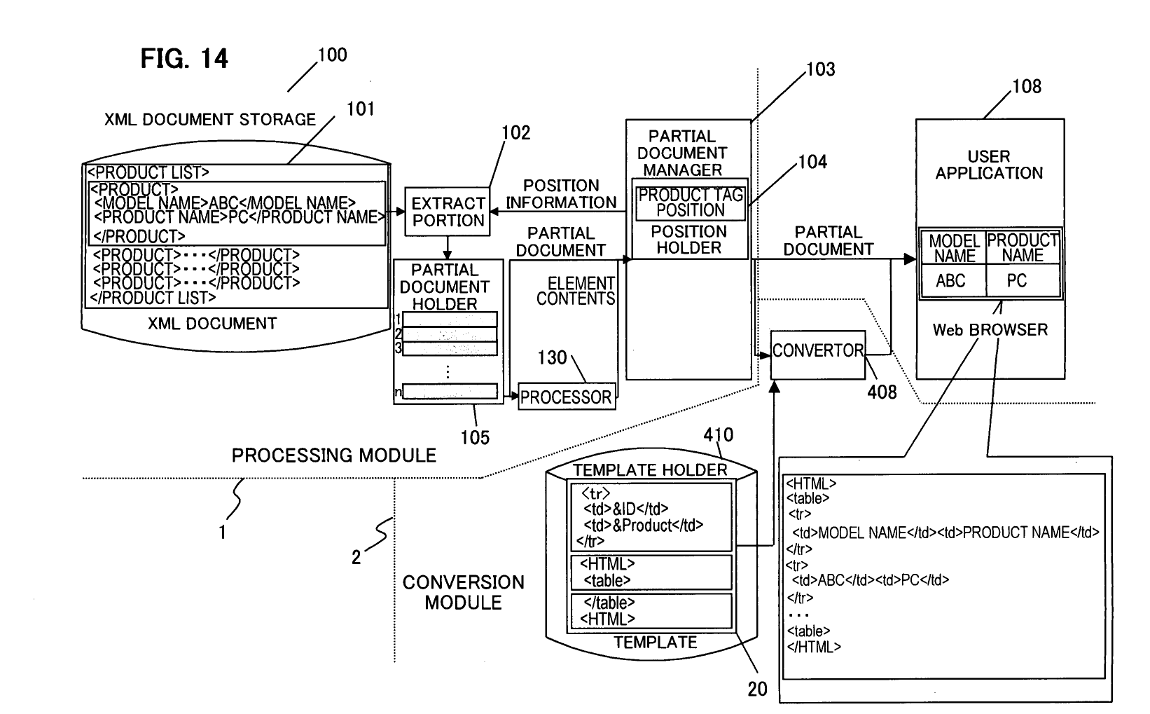

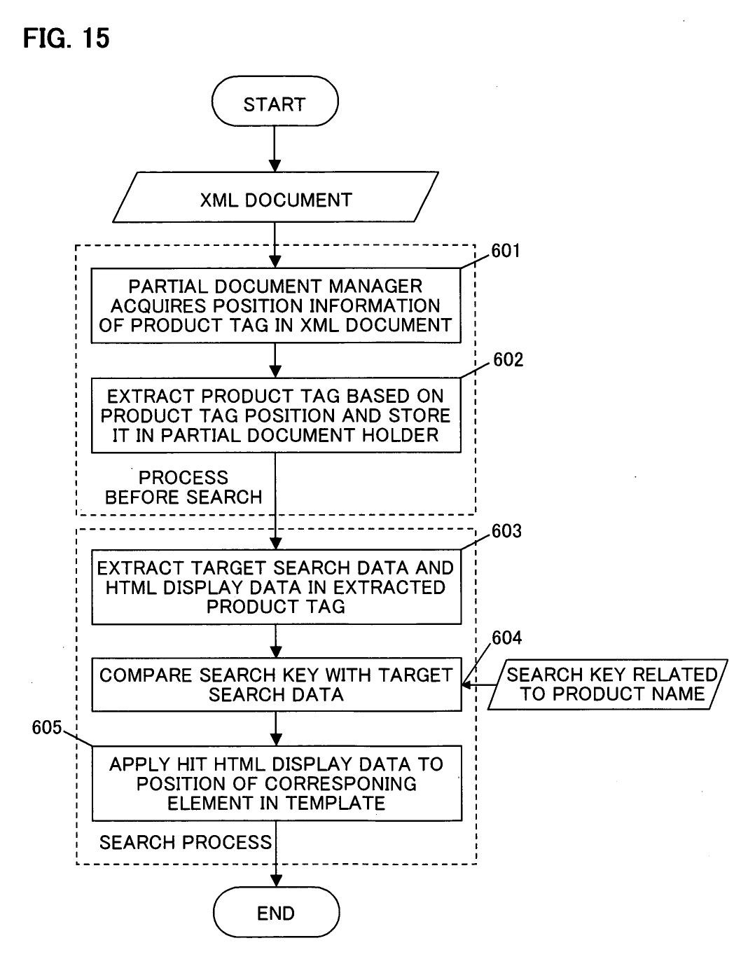

FIG. 14 shows the configuration of the system of the third embodiment of the invention, and FIG. 15 shows the flow of search processing.

In this example, as the search results, data for the model name tag and product name tag which are in a parent-child relation with a product tag is displayed. As shown in FIG. 14, a processing module 1 and conversion module 2 are provided. The processing module 1 extracts partial documents, and the conversion module 2 performs HTML conversion based on the extracted partial documents and an HTML conversion template 20.

The structured document holding portion 100, extraction portion 102, partial document management portion 103, partial document holding portion 105, and position information holding portion 104 are the same as those explained using FIG. 5. The processing portion 130 acquires position information for the model name tags and product name tags in the product tags stored in the partial document holding portion 105, and based on these retrieves model name data and product name data (element contents).

The conversion module 2 has a conversion portion 408 and a template holding portion 410. The template holding portion 410 is memory which holds, as a template, the beginning of an HTML table definition (<HTML>, <table>), the end of the table definition (<HTML>, </table>), and the table contents (<tr> to </tr>).

The conversion portion 408 performs processing to apply the product name data and model name data of hits to the template stored in the template holding portion 410. The processing portion 130 and conversion portion 408 are functional modules of the CPU.

Next, search processing in the system of FIG. 14 is explained using the search processing flow diagram of FIG. 15.

S601: As search preprocessing, the partial document management portion 103 retrieves position information for product tags in the structured document 101 from the structured document holding portion 100, and stores the position information in the position information holding portion 104. That is, as explained using FIG. 6 through FIG. 8, the positions of the element beginning and ending tags are retrieved as position information for a product tag, and are stored in a table in the position information holding portion 104, as in FIG. 8.

In addition to thus retrieving and holding position information for the product tags in the entire XML document 101, one or two among the model name elements, product name elements, and attribute values can be similarly processed, according to instructions by the user.

S602: The extraction portion 102 extracts product tags from the structured document 101 based on position information (product tag positions) in the position information holding portion 104, and stores the product tags in the partial document holding portion 105.

S603: The processing portion 130 retrieves, from the position information holding portion 104, position information for the model name tags and product name tags within product tags stored in the partial document holding portion 105, and based on this retrieves model name data and product name data. That is, the search data with tags removed, or HTML data, is extracted.

S604: A search key is retrieved from the user application 108, and the processing portion 130 compares the search data and search key.

S605: When the result of comparison is a hit, the conversion portion 408 applies the product name data and model name data to the template 20 stored in the template holding portion 410. This is transmitted to the user application 108 as an HTML document.

In this way, partial documents are obtained in stages and in detail. In many cases, data is collected to form one record, and a plurality of such records exist. In such cases, each record is initially a partial document, the position information for the partial document is acquired, and when there is a need to view the internal data in detail, position information for specific tags within each record (partial document) is acquired and data is extracted.

Further, the CPU load involved in conversion into another structured document (here, an HTML document) can be reduced. That is, in the case of the above-described XSLT, the required element contents are acquired while analyzing and interpreting a given tree structure. Because of this, portions of the tree structure can be specified flexibly. However, because there is a correspondingly high load on the CPU, the CPU calculation speed is lowered, and time is required for HTML conversion in mobile equipment or similar, making such a method difficult to use in actual practice.

Instead, an extraction portion and processing portion are used to extract element contents and apply them to an HTML conversion template 20 prepared in advance. By this means HTML conversion is possible without using XSLT, and the CPU load is reduced.

Other Embodiments

In the above-described embodiments, the structured documents are XML documents; but application to structured documents in SGML, HTML, and other formats is also possible. Similarly, converted structured documents are not limited to HTML, and use with other formats is also possible.

This invention has been explained through embodiments, but various other modifications are possible within the scope of the invention, and such modifications are not excluded from the scope of the invention.

Position information for specific tags which are branches in a structured document are retrieved in advance, and based on this position information, such partial documents as elements, attributes, and element contents are extracted from the structured document, so that only portions are extracted from the original structured document; hence compared with conventional methods involving acquisition as a tree structure, the load on the CPU can be reduced and the amount of memory used can be decreased.

Further, extracted partial documents are directly applied to a template for document conversion to generate another structured document. Through this direct application, XSLT conversion becomes unnecessary, and the CPU load is reduced further. Hence structured document processing can be executed at high speed even by equipment with low processing performance.

1. A structured document processing method for processing a structured document held in a structured document holding unit, comprising the steps of:
holding, in a position information holding section, position information for a tree in the structured document; and
extracting a specified partial document of said structured document, using said tree position information thus held.

2. The structured document processing method according to claim 1, further comprising the steps of:
holding said extracted partial document in a partial document holding unit;
judging whether a partial document for extraction is held in said partial document holding unit;
extracting said partial document from said partial document holding unit when said partial document for extraction is held in said partial document holding unit; and
extracting said partial document from said document holding unit portion by using said tree position information when said partial document for extraction is not held in said partial document holding unit.

3. The structured document processing method according to claim 2, further comprising a step of holding, in said partial document holding unit, an edited partial document of said structured document.

4. The structured document processing method according to claim 3, further comprising:
a step of copying unedited portions of said structured document in said structured document holding unit; and
a step of generating a modified partial document by combining the copied portions with the edited partial document in said partial document holding unit.

5. The structured document processing method according to claim 2, further comprising a step of extracting internal data of said partial document from the partial document held in said partial document holding unit, using the position information in said position information holding portion.

6. The structured document processing method according to claim 1, further comprising a step of applying said extracted partial document to a template for structured document conversion, and thereby performing conversion of the structured document.

7. The structured document processing method according to claim 1, wherein said extraction step comprises a step of extracting, as said partial document, at least one among a region surrounded by specific tags, tag attributes, and a region enclosed between the end of an opening tag and the beginning of a closing tag, according to the position information in said position information holding unit.

8. The structured document processing method according to claim 3, further comprising a step of storing, in said structured document holding unit, said edited partial document and position information held in said position information holding unit.

9. A structured document processing system for processing a structured document held in a structured document holding unit, comprising:
a position information holding unit which holds position information for a tree in a structured document in said structured document holding unit; and
a processing unit which extracts a specified partial document of said structured document using said tree position information thus held.

10. The structured document processing system according to claim 9, further comprising a partial document holding unit which holds said extracted partial document,
wherein said processing unit decides whether a partial document for extraction is held in said partial document holding unit, and extracts said partial document from said partial document holding unit when said partial document for extraction is held in said partial document holding unit, and extracts said partial document from said structured document by using said tree position information when said partial document for extraction is not held in said partial document holding unit.

11. The structured document processing system according to claim 10, wherein said processing unit holds, in said partial document holding unit, an edited partial document in said structured document.

12. The structured document processing system according to claim 11, wherein said processing unit copies unedited portions of said structured document in said structured document holding unit, and generates a modified partial document by combining the copied portions with the edited partial document in said partial document holding unit.

13. The structured document processing system according to claim 10, wherein said processing unit extracts internal data of said partial document from the partial document held in said partial document holding unit, using the position information in said position information holding unit.

14. The structured document processing system according to claim 9, wherein said processing unit applies said extracted partial document to a template for structured document conversion to perform conversion of a structured document.

15. The structured document processing system according to claim 9, wherein said processing portion extracts, as said partial document, at least one among a region surrounded by specific tags, tag attributes, and a region enclosed between the end of an opening tag and the beginning of a closing tag, according to the position information in said position information holding unit.

16. The structured document processing system according to claim 11, wherein said processing unit stores, in said structured document holding unit, said edited partial document and position information held in said position information holding unit.

17. A computer-readable program for processing a structured document held in a structured document holding portion, which causes a computer to execute the steps of:
holding, in a position information holding portion, position information for a tree in the structured document; and
extracting a specified partial document of said structured document, using said tree position information thus held.

18. The program according to claim 17, causing a computer to further execute the steps of:
holding said extracted partial document in a partial document holding portion;
deciding whether a partial document for extraction is held in said partial document holding portion; and
extracting said partial document from said partial document holding portion when said partial document for extraction is held in said partial document holding portion, and extracting said partial document from said structured document by using said tree position information when said partial document for extraction is not held in said partial document holding portion.

19. The program according to claim 18, causing a computer to further execute a step of holding, in said partial document holding portion, an edited partial document of said structured document.

20. The program according to claim 19, causing a computer to further execute a step of copying unedited portions of said structured document in said structured document holding portion, and generating a modified partial document by combining the copied portions with the edited partial document in said partial document holding portion.

21. The program according to claim 18, causing a computer to further execute a step of extracting internal data of said partial document from the partial document held in said partial document holding portion, using the position information in said position information holding portion.

22. The program according to claim 17, causing a computer to further execute a step of applying said extracted partial document to a template for structured document conversion, and performing conversion of the structured document.

23. The program according to claim 17, causing a computer to execute, as said extraction step, a step of extracting, as said partial document, at least one among a region surrounded by specific tags, tag attributes, and a region enclosed between the end of an opening tag and the beginning of a closing tag, according to the position information in said position information holding portion.

24. The program according to claim 19, causing a computer to further execute a step of storing, in said structured document holding portion, said edited partial document and position information held in said position information holding portion.
